(19) United States
(12) Patent Application Publication
(10) Pub. No.: US 2019/0111933 A1
(43) Pub. Date: Apr. 18, 2019

(54) METHOD FOR PRODUCING CONTROL DATA FOR RULE-BASED DRIVER ASSISTANCE

(71) Applicant: AVL List GmbH, Graz (AT)

(72) Inventors: Peter Schoeggl, Hitzendorf (AT); Juergen Holzinger, Graz (AT); Uwe Dieter Grebe, Graz (AT); Mario Oswald, Fernitz (AT)

(73) Assignee: AVL List GmbH, Graz (AT)

(21) Appl. No.: 16/089,409

(22) PCT Filed: Mar. 29, 2017
(86) PCT No.: PCT/EP2017/057376

§ 371 Date: Sep. 28, 2018

(30) Foreign Application Priority Data
Mar. 29, 2016 (DE) 10 2016 205 153.9

(51) Int. Cl. B60W 40/09; B60W 30/095; B60W 30/18; B60W 50/00; B60W 50/10

(52) U.S. Cl. CPC B60W 40/09; B60W 30/0953; B60W 30/18163; B60W 2550/30; B60W 50/10; B60W 2050/0089; B60W 50/0097

(57) ABSTRACT

A method for producing control data for rule-based driver assistance for guiding a vehicle by a driver assistance system is provided. The method includes detection of values of at least one adjustment parameter for guiding the vehicle and/or a body parameter which at least partially characterizes body functions of a vehicle passenger. The method also includes detection of values of at least one input parameter which at least partially characterizes a driving scenario; determining at least one boundary condition for adjusting the at least one adjustment parameter according to the at least one input parameter based on the detected values; and emission of control data for guiding the vehicle, which takes into account the at least one boundary condition as a rule.

### CROSS-REFERENCE TO RELATED APPLICATIONS

This application is a national phase entry of, and claims priority to, International Application No. PCT/EP2017/057376, filed Mar. 29, 2017, which claims priority to German Patent Application No. 10 2016 205 153.9, filed Mar. 29, 2016, both with the same title as listed above. The above-mentioned patent applications are incorporated herein by reference in their entireties.

### TECHNICAL FIELD

The present invention relates to a method for producing control data for rule-based driver assistance for guiding a vehicle, particularly by a driver assistance system, as well as such a driver assistance system. In the method according to the invention, boundary conditions are determined for guiding the vehicle and control data which takes the boundary conditions into account is emitted for guiding the vehicle.

### BACKGROUND

A plurality of different sensor systems is known from the prior art for detecting a vehicle's surroundings. These sensor systems for example enable detecting lane boundaries on the road or determining the distance from a vehicle in front and thus a relative position of the vehicle in front. The known sensor systems can also determine a relative speed to the vehicle ahead.

Based on this information compiled by the sensor systems, vehicles can be operated in automated modes of operation. In these operating modes, particularly in a highly automated or fully automated operating mode, the driver is partially or even fully relieved of guiding the vehicle.

A highly automated vehicle is hereby a vehicle in which a driver assistance system assumes the longitudinal and lateral guidance for a certain time period and/or in specific situations, whereby the driver does not thereby monitor the system, however is prompted to guide the vehicle when needed with sufficient notification. The driver assistance system itself is preferably cognizant of its own limits. However, the driver assistance system is not capable of effecting the minimum-risk situation out of every initial situation.

A fully automated vehicle is hereby a vehicle in which a driver assistance system fully assumes the longitudinal and lateral guidance in a defined scenario, the driver does not thereby need to monitor the system. Before exiting the scenario, the driver assistance system preferably prompts the driver to assume the guidance of the vehicle with sufficient notification. Should this not occur, the driver assistance system preferably returns to the minimum-risk situation. The driver assistance system itself is preferably cognizant of its own limits. The driver assistance system is preferably capable of effecting the minimum-risk situation in all situations by itself.

Driver assistance systems for highly automated or fully automated vehicles hereby consolidate a plurality of functions such as, for example, lane departure assistance, lane change assistance, lane changing guidance, road sign recognition, emergency braking system, emergency stop system, adaptive speed control, etc., to be able to reliably realize lateral and longitudinal guidance.

Printed publication EP 2 942 765 A1 relates to a system for assisting a driver of a vehicle during potential lane change procedures. The method realized by the system comprises the steps of at least one sensor generating sensor data which physically detects the vehicle's surroundings, predicting the future movement behavior of at least one detected vehicle, and determining whether there is a gap in a lane adjacent to the vehicle. If a neighboring lane of the vehicle is more suitable for the predicted future movement behavior, a recommendation is generated as to the feasibility of a vehicle lane change to the better suited lane, wherein the result combines the determination of a gap being present and the future movement behavior of the least one detected vehicle. Based on this recommended information, a notification is output to the vehicle driver when a lane change is feasible.

Printed publication WO 2013/138000 A1 relates to a method for operating a vehicle in an autonomous mode of operation. The method comprises the following operating steps: using a computer system to determine a current state of a vehicle, whereby the vehicle is configured to operate in an autonomous mode; using a computer system to determine a current state of the surroundings of the vehicle, whereby the vehicle's surroundings include at least one other vehicle; using a computer system to determine a predicted behavior of the at least one other vehicle on the basis of the at least one current state of the vehicle and the current state of the vehicle's surroundings; using a computer system to determine a confidence level, whereby the confidence level includes a likelihood of the at least one other vehicle performing the predicted behavior and whereby the confidence level depends on at least the predicted behavior, the current state of the vehicle and the current state of the vehicle's surroundings; and using a computer system to control the vehicle in the autonomous mode based on the predicted behavior, the confidence level, the current state of the vehicle and the current state of the vehicle's surroundings.

Printed publication U.S. Pat. No. 9,248,843 B1 relates to a computer-implemented method for detecting objects in the surroundings of a vehicle and reacting to same. An object in the surroundings of the vehicle can hereby be identified, whereby the object has a direction of movement and a location. A set of possible actions can be generated for the object using map information which depicts the surroundings of the vehicle and the direction of movement and location of the object. A set of possible future trajectories of the object is generated based on the possible actions and a probability value of each trajectory of the set of possible future trajectories is determined based on contextual information including detected object status. A final future trajectory is determined based on the determined probability values for each trajectory of the set of possible future trajectories. The vehicle is then manipulated to avoid the final future trajectory and the object.

Printed publication WO 2015/032508 A1 relates to a method for optimizing a driver assistance system comprising the following operating steps: specifying at least one driver assistance system A to be optimized; determining at least one vehicle parameter function characterizing an operating state of a vehicle and at least one environmental parameter function characterizing the surroundings of the vehicle; calculating at least one driving situation characteristic value function characterizing a driving situation of the vehicle, at least on the basis of the at least one vehicle parameter function and/or the at least one environmental parameter function; calculating at least one control intervention characteristic value function which characterizes the activity of the driver assistance system A; calculating a correction function depending on the at least one driving situation characteristic function and characterizing a subjective perception of the driving situation by at least one vehicle occupant at least on the basis of the at least one control intervention characteristic function and on the basis of the at least one vehicle parameter function and/or the at least one environmental parameter function.

Printed publication DE 10 2014 208 311 A1 relates to a driver assistance system having an operating mode for fully automated vehicle guidance of a motor vehicle, whereby the fully automated vehicle guidance is individualized by being adapted to the individual needs of a driver.

Printed publication DE 10 2006 039 583 A1 relates to a driver assistance system having assistance functions determinable by parameters, wherein the driver assistance system is adaptively configured by variable parameters.

### SUMMARY

It is a task of the invention to provide an improved method for assisting a driver in the guiding of a vehicle and an improved corresponding driver assistance system. In particular, it is a task of the invention to improve subjective perception of the driver with respect to the driver assistance system's guidance of the vehicle.

This task is solved by a driver assistance system and a method for assisting a driver in the guiding of a vehicle. Advantageous embodiments are described herein.

A first aspect of the invention relates to a method for producing control data for rule-based driver assistance for vehicle guidance, particularly by a driver assistance system, which preferably comprises the following operating steps:

Detecting values of at least one adjustment parameter for guiding the vehicle and/or a body parameter which at least partially characterizes the body functions of a vehicle occupant, particularly the driver;

Detecting values of at least one input parameter which at least partially characterizes the driving scenario;

Determining at least one boundary condition for adjusting the at least one adjustment parameter according to the at least one input parameter based on the detected values; and

Emitting control data for guiding the vehicle which takes into account the at least one boundary condition as a rule.

A second aspect of the invention relates to a driver assistance system for assisting a driver in the guiding of a vehicle which preferably comprises at least one sensor configured to at least partially detect driving situation data related to the vehicle and/or body parameter data of the driver. The driver assistance system preferably further comprises a driving style selector module, wherein the driving style selector module comprises a data storage and is configured to access the driving situation data and/or body parameter data of the at least one sensor and data from at least one adjustment parameter for guiding the vehicle, such as via CAN interface. The driving style selector module is configured to store values of the at least one adjustment parameter and the sensor data in the data storage and determine at least one boundary condition in relation to the at least one adjustment parameter as a function of the stored data. Further preferably, the driver assistance system comprises an interface for emitting vehicle guidance control data which takes into account the at least one boundary condition as a rule.

Traffic data in the sense of the invention relates to the absolute and/or relative position of other users of the road to the vehicle as well as contextual information relating to these positions. For example, traffic density and thus for example expected traffic congestion can be concluded from the positions. Furthermore, traffic data can also include the speed and/or acceleration of the other users of the road as well as environmental data, for example weather conditions, within a section of the route relevant to the vehicle.

A driver assistance system in the sense of the invention enables highly automated or fully automated guidance of the vehicle.

A driving situation in the sense of the invention comprises information on the state of the vehicle, in particular longitudinal speed, lateral speed, longitudinal acceleration, lateral acceleration, steering angle, throttle position and lane as well as the state of the other road users in the immediate surroundings of the vehicle; i.e. those users of the road who are theoretically observable, in particular visible, from the vehicle's perspective. A driving situation is hereby in particular a status analysis at any given time. Pursuant to the invention, there are thus preferably different driving scenarios at different points in time, even if there is no change in the constellation of the other road users around the vehicle at the different times.

A driving scenario in the sense of the invention describes an interaction of a vehicle with its environment. In particular, the driving scenario comprises information on the driving situation. Preferably, the driving scenario comprises further information about the traffic, the weather condition and/or road data on the section of the route relevant to the vehicle. A driving scenario is preferably a comprehensive consideration of a plurality of, and more preferably all, the parameters relevant to the movement of the vehicle. A driving scenario is hereby in particular a status analysis at any given time. Pursuant to the invention, there are thus preferably different driving scenarios at different points in time, even if there is no change in the constellation of the other road users around the vehicle at the different times.

An adjustment parameter in the sense of the invention is an adjustment of a vehicle regulating variable serving in controlling vehicle operation. Adjustment parameters include throttle/accelerator position, braking pressure/signal, gear selection, etc.

Road data in the sense of the invention comprises at least information on the topography of the section of road ahead. Preferably, road data also comprises information on the course of the roadway over the respective route section.

A module in the sense of the invention is a component of a computer system. A module can thereby in particular be realized as hardware and/or software.

A trajectory in the sense of the invention is the chronological course of a physical body's movement, such as a vehicle or other road user.

A driving style in the sense of the invention is the manner and way in which a vehicle is guided. A driving style is characterized by the behavior of the driver or a vehicle-guiding driver assistance system in different driving scenarios.

Preferably, these behaviors relate to driving scenarios in which the driver needs to make changes in the state of the vehicle, for example initiating a passing maneuver or a lane change, etc.

Control data in the sense of the invention is data which can be used to control a vehicle. The control data thereby comprises at least one allocation rule, such as a function or a table indicating the at least one boundary condition.

A boundary condition preferably refers to at least one constellation of at least input parameters, the values of which are associated with adjustment parameters and/or body parameters. The values of the adjustment parameters and/or body parameters hereby contain information about the occupant's subjective perception and/or his probable behavior as relates to a driving scenario.

A driving style attribute in the sense of the invention is suitable for characterizing the subjective perception of a driver or a group of drivers in relation to the driving style of a driver assistance system. Driving style attributes include the driving time; i.e. the rate of speed which the driver assistance system attempts in order to cover a distance, a sense; i.e. subjective perception, of safety, perceived efficiency, driving dynamics and drivability; i.e. a subjective perception of the vehicle's driving performance as a reaction to the driver assistance system actions. Further driving style attributes are preferably such properties which although do not trigger a subjective perception or impression in the driver, their objective values may still be of interest to the driver. This for example includes emission as well as actual energy consumption.

The invention is based on the realization that the evaluation of a driver assistance system in automated or fully automated vehicle guidance will in the future depend to a very significant degree on the subjective perception the driver has during the driving actions of the driver assistance system. It is therefore advantageous for the driver assistance system to not only take into account legal regulations such as speed limits or no-passing zones, etc., and safety aspects for preventing accidents when determining a destination, but to also factor in one or more crucial boundary conditions for the driving experience of a vehicle occupant and/or a definitive assessment of a route travelled by the driver assistance system. This is inventively ensured by the incorporating of boundary conditions pertaining particularly to driving style attributes.

A further realization impacting the invention is that of driver assistance systems, unlike drivers, being capable of incorporating information through the possibility of digital information processing which goes far beyond the current driving situation when planning the trajectory of the vehicle. By exchanging data with other vehicles (car-to-car) or with the infrastructure (car-to-infrastructure) as well as drawing on topographical data and roadway data, prospective driving scenarios can be simulated.

It is to be noted at this point that the driver assistance system generally has more information at its disposal than the occupants of the vehicle, particularly the driver. Having knowledge of the topography or even the density of traffic or the braking of a vehicle which is not at that moment visible, the vehicle can select an anticipated optimized trajectory in terms of safety or energy efficiency aspects. Since the driver does not have this information and is also not normally capable of processing a corresponding amount of parallel information as the driver assistance system, the driver assistance system's manner of optimized driving based on purely objective criteria can lead to driver uncertainty or discontent because he cannot follow the decisions made by the driver assistance system.

In light of the above, the invention proposes determining boundary conditions relative to the driving habits and/or boundary conditions relative to the driver's perception as characterized by the body data of the occupant so that the driver assistance system can adapt an objectively ideal trajectory to human expectation when guiding the vehicle.

By combining dynamic driving scenario simulation with the prediction of traffic events for a predictive driver assistance system driving style coupled with the factoring in of the boundary conditions particularly characterizing driving style attributes of a driver or group of drivers, the highly automated or respectively fully automated guiding of the vehicle can simultaneously be optimized in terms of both objective and subjective criteria.

The inventive method and apparatus enable the vehicle to adjust to the respective occupant or driver or even to the vehicle configuration subsequent a type of training phase in which the control data is produced. After a short period of time subsequent a change in driver or a short distance travelled respectively, a driver assistance system can in this way determine whether the driver is satisfied with the driver assistance system's driving style and if necessary make modifications to said driving style. It can moreover be deter-mined whether the vehicle is behaving differently, for example due to a change in load or a change in tire pressure or the like. The driving style can also be inventively modified based on such changes determined in the vehicle configuration. It can further be provided to continually update the adjustments based on the inventive method in the manner of a control loop to be able to adjust to vehicle parameter changes.

In one advantageous embodiment, the method according to the invention comprises at least intermittent guiding of the vehicle based on the control data.

In a further advantageous embodiment of the inventive method, the at least one boundary condition emulates a driver or driver group driving style. A driver group driving style can for example be identified by statistically evaluating driving data from multiple drivers, whereby driver groups can be formed for example based on gender, age, etc.

In a further advantageous embodiment of the inventive method, the at least one boundary condition emulates an adapted driver or driver group driving style which reflects the different driver or driver group perceptions between automatic and manual vehicle guidance. Depending on risk-taking affinity and confidence in technology, different occupants or respectively different drivers expect a different manner of driving from a driver assistance system than the individual driving style of the driver or occupant. Thus, drivers or occupants with a high affinity to risk can expect a driver assistance system to push physical driving limits closer to their limit than the driver himself would trust doing, for example due to lack of driving experience. This function of the invention is particularly important given that drivers' own experience in driving manually will presumably decrease sharply in the future.

In a further advantageous embodiment of the inventive method, at least some values are recorded during the automatic guiding of the vehicle by the driver assistance system. In this embodiment, body parameters of the vehicle occupant are detected to be able to replicate the subjective perception as relates to the driving style of a driver assistance system.

In a further advantageous embodiment of the inventive method, the at least one adjustment parameter indicates whether the driver will stop automatic vehicle guidance by the driver assistance system upon a constellation of the at least one adjustment parameter with the at least one input parameter. Particularly in those situations in which the driver stops the automatic guidance, it can be concluded that the driver perceived a shortcoming in the driver assistance system guidance in terms of his subjectively perceived perception of safety. A driver assistance system should therefore devise alternative driving strategies for such a driving scenario to give the driver an improved driving experience.

In a further advantageous embodiment, the inventive method further comprises the operating step of simulating, concurrent with guiding the vehicle, at least one future driving scenario on the basis of the values of the at least one input parameter and simulating at least one vehicle trajectory on the basis of the at least one future driving scenario, whereby the control data is based on the at least one simulated trajectory. Simulating future driving scenarios enables them to be considered during vehicle guidance and thus achieves optimal guidance.

In a further advantageous embodiment of the inventive method, the simulation occurs in real time, in particular based on the real-time data of the present driving scenario.

In a further advantageous embodiment of the inventive method, a plurality of possible prospective trajectories is simulated, and the method further comprises an operating step of evaluating the plurality of possible trajectories based on at least one boundary condition, wherein the control data reflects the best-rated prospective trajectory.

In a further advantageous embodiment of the inventive method, the at least one boundary condition characterizes a driving style attribute from the following group: driving time, emission, energy consumption, safety, driving dynamics, drivability, perceived efficiency, perceived safety.

In a further advantageous embodiment of the inventive method, the simulation occurs periodically, preferentially at an intermittency of approximately 1 second to approximately 10 minutes, more preferentially approximately 10 seconds to approximately 1 minute, and most preferentially approximately 1 second, approximately 10 seconds, approximately 1 minute or 10 minutes.

In a further advantageous embodiment of the inventive method, the simulation encompasses a future time period of approximately 1 second to approximately 10 minutes, preferentially approximately 10 seconds to approximately 1 minute, and most preferentially approximately 1 second, approximately 10 seconds or approximately 1 minute.

In a further advantageous embodiment of the inventive method, a plurality of boundary conditions is considered, with their driving style attributes being weighted differently. Some driving style attributes can thereby be considered to a disproportionately higher extent and other driving style attributes to a disproportionately lower extent during the optimization.

In a further advantageous embodiment of the inventive method, the evaluation ensues based on a cost function into which the at least one boundary condition is incorporated.

In a further advantageous embodiment of the inventive method, the determining of the at least one boundary condition provides for the at least one body parameter to not exceed at least a predefined limit value and/or to lie within at least a range of values.

In a further advantageous embodiment of the inventive method, the driver is at least partially apprised of the driving scenario and/or a future driving scenario during the guidance of the vehicle. This background information enables the driver to better evaluate the driver assistance system's guidance. This pertains to circumstances which the driver cannot (yet) perceive due to their not being in his field of view or arising from a simulated future driving scenario.

In another embodiment, a computer program contains instructions which, when run on one computer or several computers, prompts the execution of the steps of the methods described above. In one aspect, a computer-readable medium is stored on the computer program.

The features and advantages described in the foregoing with respect to the first aspect of the invention and its advantageous embodiments also apply analogously to the second aspect of the invention.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrates one or more embodiments of the invention and, together with the general description given above and the detailed description given below, explains the one or more embodiments of the invention.

FIG. 1 shows a schematic view of a vehicle with a driver assistance system according to one embodiment of the invention.

FIG. 2 shows a flow chart depicting one embodiment of an operational sequence of a method according to the invention.

FIG. 3 shows a top view of a first example driving scenario depiction.

FIG. 4 shows a top view of a second example driving scenario depiction.

FIG. 5 shows a side view of a further depiction of the first driving scenario depiction of FIG. 3.

FIG. 6 shows a top view of a third example driving scenario depiction.

FIG. 7 shows a top view of a fourth example driving scenario depiction.

### DETAILED DESCRIPTION

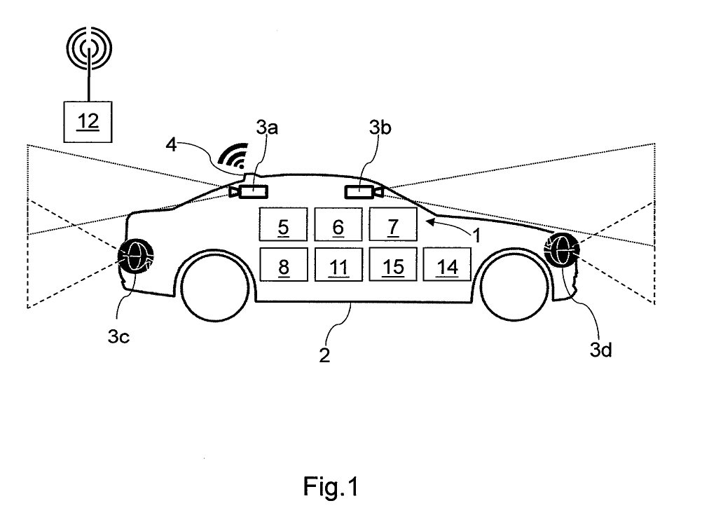

FIG. 1 shows a vehicle 2 comprising an embodiment of the inventive driver assistance system 1. The driver assistance system 1 thereby comprises a plurality of sensors 3a-3d, these being a rear-facing camera 3a, a forward-facing camera 3b, a forward-facing radar system 3d and a rear-facing radar system 3c in the example depicted in FIG. 1. The data recorded by the individual sensors is transmitted by preferably wireless or wired connection to a prediction module 6 of the driver assistance system 1. Further elements of the driver assistance system 1 are a first data interface 4, able to establish a data link with an infrastructure, in particular a central traffic server 12, for example via a mobile transmitter mast, and a second data interface 5, which is preferably connected to a second data storage 11 by a data link, in which roadway data is further preferably stored. Traffic data can thus be received and/or retrieved via the infrastructure, for example the data server 12, as can traffic data directly from other road users 13a-13g, via the first data interface 4, which is preferably designed as a wireless interface. Road data such as topography, roadway course, infrastructure details, etc. of a relevant section of road can be read into the driver assistance system 1 via the second data interface 5 and processed there. The second data interface can in principle also be designed as a wireless interface and the road data obtained from the data server 12 or another source.

Additionally, or alternatively to sensors 3a-3d, a plurality of other sensors is possible, for example ultrasonic and/or lidar sensors.

The sensors can monitor the driving situation of the vehicle in traffic. For instance, an ultrasonic sensor can for example monitor the immediate surroundings of the vehicle, for example when parking, and a radar system can determine the distance and the relative speed, particularly acceleration, to other vehicles in the field of view of the vehicle 2. A lidar sensor can detect objects in the surroundings of the vehicle 2 and also distances to other vehicles and the camera can detect and if necessary even identify the lane as well as road signs or also objects in the surrounding area of the vehicle 2.

The driver assistance system 1 is thereby preferably designed to guide the vehicle 2 in highly automated or even fully automated manner. To that end, that information which the driver assistance system 1 can detect with its in-vehicle (on-board) sensors 3a-3d is of primary relevance. This is particularly important when the driver assistance system 1 does not have a data connection to the central data server 12, other infrastructure or other road users 13a-13g since the driver assistance system 1 must then guide the vehicle 2 autonomously in that case while ensuring the highest possible safety for the vehicle 2 and its occupants.

If other data is included additionally to the information from the sensors 3a-3d associated with the driver assistance system 1 as was transmitted by the infrastructure or other road users 13a-13g, in particular road users in front, the driver assistance system 1 can then realize an even more predictive manner of driving than is possible according to the invention just with the data of the driver assistance's own sensors 3a-3d alone.

The driver assistance system 1 according to FIG. 1 further comprises a prediction module 6 designed to simulate future driving scenarios based on a current driving scenario and/or past driving scenarios. Moreover, traffic data and road data as well as data on the weather conditions at the location of the vehicle 2 or another location at a relevant section of the route are incorporated into the simulation of the prediction module 6.

Based on the future driving scenario, the prediction module 6 subsequently simulates a plurality of possible vehicle trajectories. These are emitted to an optimization module 7 which can in turn select one of the trajectories 10a, 10b as an ideal trajectory. This type of simulation can be visualized as gazing into a crystal ball; i.e. foreseeing a driving scenario or such a driving situation as is highly like to occur. For example, a progression of stop-and-go traffic in traffic jams generally known as the accordion effect as well as the spreading of said accordion effect through the traffic jam can be predicted and the trajectory of one's own vehicle 2 intelligently adapted to this development.

A control module of the driver assistance system is connected via a data link to the controls of the steering system, the brake system and/or the drive system of the vehicle 2 to implement the respective trajectories 10a, 10b, 10c.

The driver assistance system 1 depicted in FIG. 1 furthermore comprises a driving style selector module 14. This driving style selector module 14 serves to detect indications from the driver and/or occupants regarding their desired driver assistance system driving style. To that end, the driving style selector module 14 comprises a user interface, e.g. a touch-sensitive display. Alternatively or additionally, it can also be provided for a mobile phone or other electronic apparatus capable of being connected to the driver assistance system 1 via a data connection to be used as the user interface. Preferably, the driving style selector module 14 is designed to independently generate driving style attributes relative to its driving style during automated driving or to a driver during manual driving. The driving style selector module 14 can to that end access driving situation data, traffic data and road data which at least partially characterizes a driving scenario. Furthermore, the driving style selector module 14 can access data relating to at least one adjustment parameter for guiding the vehicle 2 and/or occupant body parameter, such as of the driver. Value constellations of the driving scenarios to the adjustment parameters are preferably stored in a second data storage 15 associated with the driving style selector module 14. The driving style selector module 14 can in this way create boundary conditions which subsequently characterize driving style attributes of the driver assistance system 1. Thus, correlations between different driving scenarios and corresponding adjustment parameter value constellations which can be used in the appropriate driving scenarios are stored in the second data storage 15.

The individual modules of the driver assistance system 1 are preferably components of a computing device in the vehicle 2, such as one or more on-board computers. The individual modules are thereby designed as hardware or software components. Sensors additionally associated with other systems of the vehicle 2 or are part of said other systems can also be used as sensors 3a-3d of driver assistance system 1.

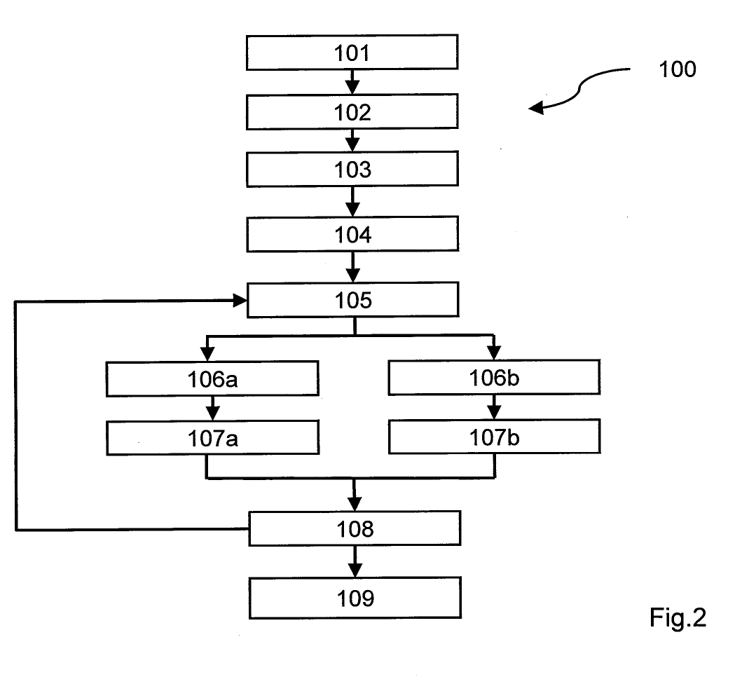

The inventive method, its exemplary embodiments depicted schematically in the FIG. 2 flow chart, will be described in the following based on FIGS. 2 to 6.

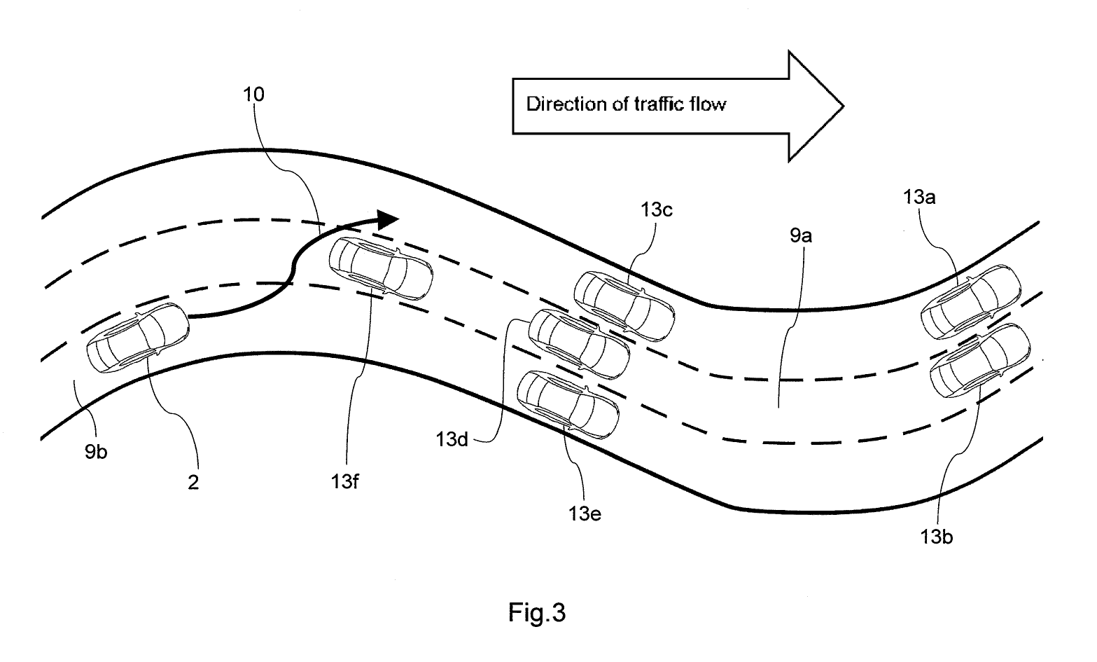

FIG. 3 shows an example of a driving scenario in which a vehicle 2 at the left edge of the image is on a three-lane road. Another vehicle 13f is driving ahead of the vehicle in the middle lane with three side-by-side vehicles 13c, 13d, 13e occupying all three lanes then in front of said other vehicle. Two vehicles 13a, 13b are driving further up ahead in the left and middle lane, likewise side-by-side. This current driving scenario is detected 102 by the sensors 3a-3d disposed in the vehicle 2. Since vehicle 2 with the driver assistance system 1 is at a faster speed than vehicle 13f ahead in the middle lane, the driver assistance system 1 will typically initiate a passing maneuver relative to vehicle 13f in this driving scenario and thereby change lanes, as indicated by arrow 10. The vehicle 2 is thereby being guided 105 by the driver assistance system 1.

According to the invention, simultaneously to guiding the vehicle 2, the driver assistance system 1 now simulates 106a, 106b other future driving scenarios, in real time. The simulation is dynamic; i.e. previously simulated driving scenarios are respectively replaced by the current one.

Based on the speeds of the vehicles in the immediate vicinity of vehicle 2 as determined by the radar detector, the driver assistance system 1 can determine through simulation 106a, 106b that the vehicle 13c driving in the left lane; i.e. the passing lane, is at a substantially lower speed than the vehicles 13d, 13e driving next to it. If vehicle 2 with the driver assistance system 1 initiates a passing maneuver at high speed and thus takes trajectory 10, as shown in FIG. 3, the driver assistance system 1 determines through simulation 106a, 106b that in a further driving scenario, vehicle 2 with the driver assistance system 1 would become wedged in a position between vehicle 13c ahead and vehicle 13f which would then be driving next to vehicle 2.

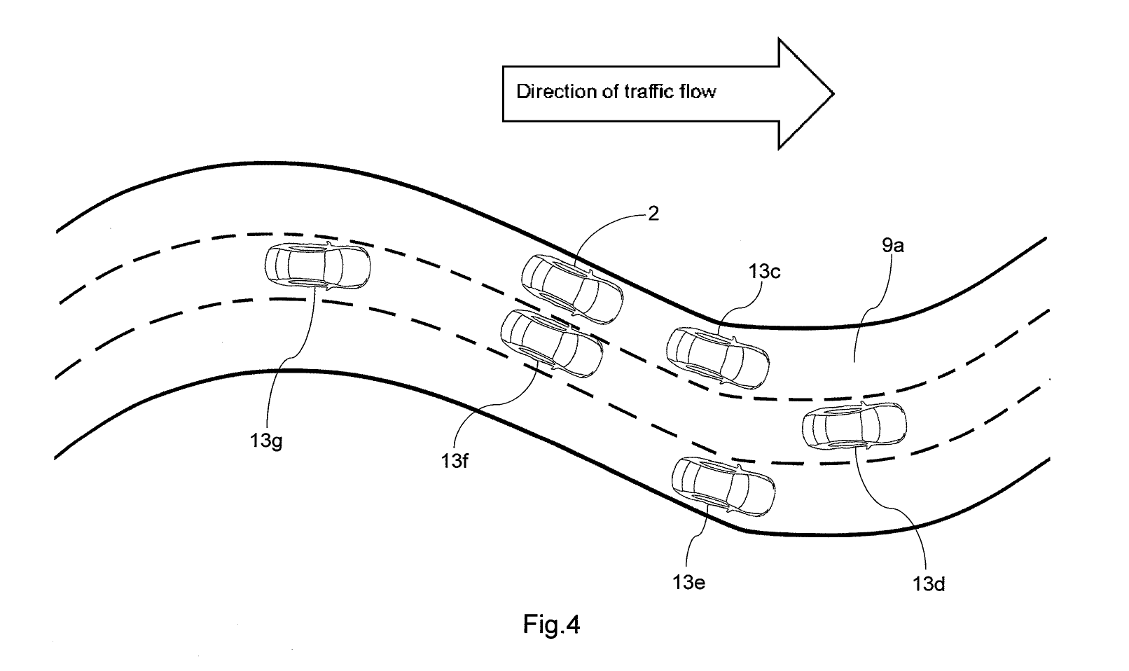

This is depicted in FIG. 4. In this driving scenario, vehicle 2 would therefore have to brake hard to adapt to the speed of vehicle 13c ahead of it in the passing lane and could not complete the passing maneuver with regard to vehicle 13f. The driving maneuver corresponding to trajectory 10 would thus evoke a subjective perception in an occupant of the vehicle 2 that the driver assistance system 1 is driving with low predictiveness, thus evoking a bad assessment of the drivability as realized by the driver assistance system 1; i.e. the driving behavior induced by the driver assistance system 1 as subjectively perceived by an occupant. The occupant will also be aware that the maneuver initiated by some acceleration or at least high speed and then abrupt deceleration behind vehicle 13c leads to lower energy efficiency or high energy consumption respectively, which likewise leaves a negative impression on the occupant.

The driver assistance system 1 therefore preferably further simulates a plurality of possible different trajectories 106a starting from the current driving scenario of FIG. 3 and in consideration of the future driving scenario of FIG. 4 and selects that trajectory 107a which evokes the most positive overall impression possible of the driving style of the driver assistance system 1 for the occupants. For example, in the current driving scenario of FIG. 3, the driver assistance system 1 can follow vehicle 13f in front, not initiate a passing maneuver or just initiate a lane change to the passing lane at a reduced speed to be able to eventually pass vehicle 13c after it possibly changes lanes to the middle lane. Alternatively, an ideal trajectory can also be calculated in direct consideration of a future driving scenario 107b.

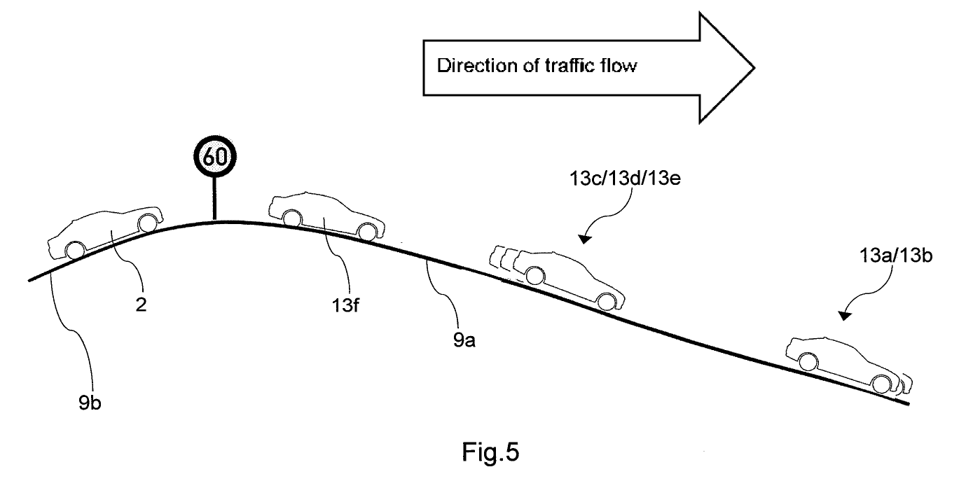

Preferably, the driver assistance system 1 of vehicle 2 can hereby also factor in the course of a section of road 9a ahead or, as depicted in FIG. 5, the expected topography on the section of road 9a ahead and if applicable whether there are further infrastructure-based factors which should be considered such as, for example, a speed limit, as likewise depicted in FIG. 5. In consideration of the topography shown in FIG. 5, the driver assistance system 1 of vehicle 2 selects a lower acceleration/speed since the simulation 106a, 106b incorporates the information that the road section 9a ahead has a downhill grade and the grade also has a stipulated speed limit.

If the driver assistance system 1 moreover incorporates real-time data detected via infra-structure and/or other road users 13a, 13b, 13c, 13ds, 13e, 13f, 13g, particularly those in front and/or behind, into the simulation of driving scenarios 106a, 106b, future driving scenarios can then be simulated even more accurately and thereby factor in information unable to be derived from detecting and evaluating the current driving situation 102.

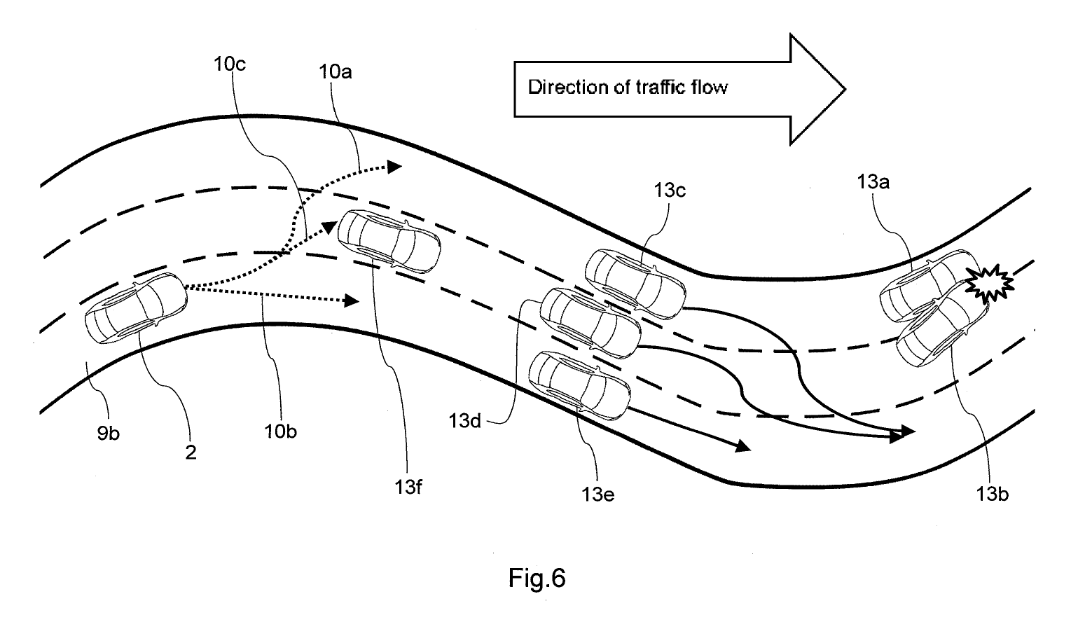

For example, FIG. 6 shows a modified driving scenario from that of FIG. 3, in which vehicles 13a and 13b driving far ahead of vehicle 2 with the driver assistance system 1 have caused a collision. If this information is transmitted to vehicle 2 under the guidance of driver assistance system 1 via infrastructure or directly by vehicles 13a, 13b or vehicles 13c, 13d, 13e, which have a direct view of the driving situation of the two vehicles 13a, 13b, then vehicle 2 can incorporate this incident into its simulation. As FIG. 6 depicts, the driver assistance system 1 can select between different trajectories 10a, 10b, 10c to contend with a future driving scenario resulting from the driving scenario in FIG. 6.

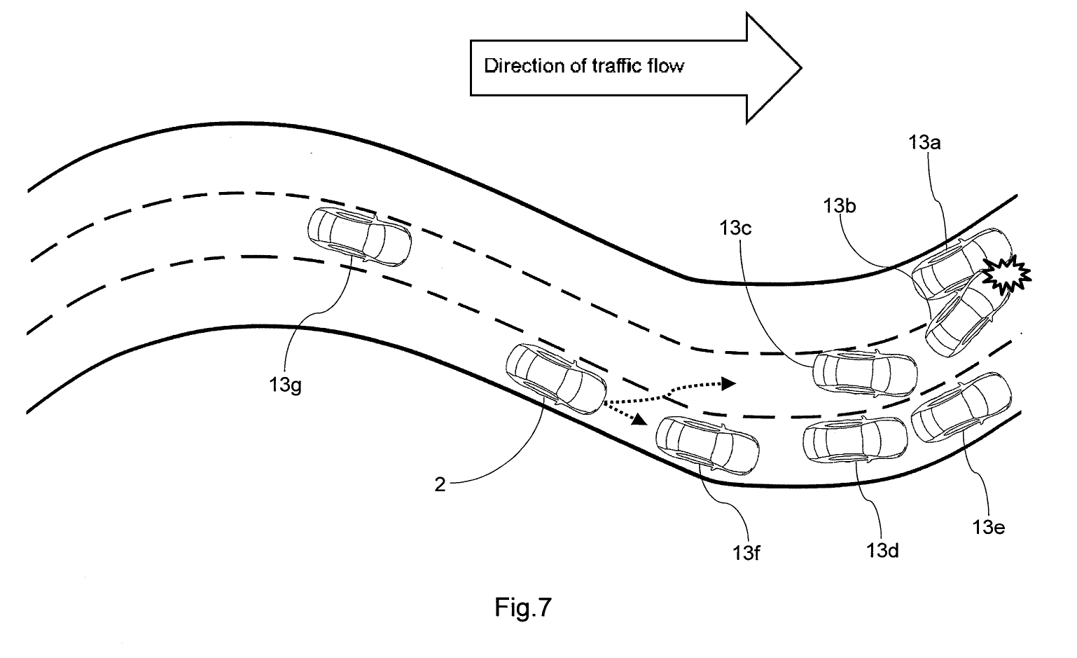

Such a future driving scenario is depicted in FIG. 7. Vehicle 2 is guided to trajectory 10b and its speed reduced since in its simulation 106a, 106b, the driver assistance system 1 anticipated that all the vehicles would have to drive in the right lane past the vehicles 13a, 13b blocked by the accident.

In the then current driving scenario of FIG. 7, the driver assistance system 1 of vehicle 2 can again select whether to stay in the right lane and follow vehicle 13f ahead or make another lane change again to pass vehicle 13f ahead by then merging back in.

According to the invention, when selecting 107a the ideal trajectory or calculating 107b the ideal trajectory respectively, boundary conditions characterizing driving style attributes are preferably factored in additionally to the result of the simulation 106a, 106b. The driving style attributes hereby indicate preferably objective criteria of how an occupant or a group of occupants characterized for example by age or gender will perceive a driving style of the driver assistance system 1 manifested in the respective trajectory. Such driving style attributes can for example be the driving time, the perceived energy consumption, the objective energy consumption, the perceived safety, the driving dynamics and/or also the drivability. Ideally, the boundary conditions emulate a driving style of the occupant or the group of occupants. However, it can hereby preferably also be taken into account that an occupant will place different demands on the driver assistance system 1 as a passenger than when he himself is driving. Different driving style attributes are preferably weighted differently in the calculation and a cost function optimization can be applied to achieve an overall optimum.

To adapt to changing environmental conditions or also properties of the vehicle 2, it can be further provided for the driver assistance system 1 to evaluate 108 trajectories travelled and/or driving scenarios. The boundary conditions can be modified accordingly to satisfy deviations from predetermined target corridors relative to the driving style attributes under the changed conditions.

Additionally, a characteristic value assessing the performance of the driver assistance system 1 can be calculated 109.

Preferably, the identifying of an ideal trajectory for the driver assistance system 1 handling of a future driving scenario is supplemented by the driver assistance system 1 communicating with selected vehicle control systems to prepare the vehicle 2 for conditions existing on a section of road 9a ahead. For example, the steering control can be informed that a vigorous steering movement is immediately imminent, or the brake control readied for imminent hard braking. The brake control can then for example generate a particularly high hydraulic pressure. The suspension can for example also be readied for road irregularities to be able to ideally compensate for them. The simulation preferably ensues at approximately 1 second intervals, with a period of the next 10 seconds up to approximately 1 minute being thereby further preferably covered.

As already described in reference to the driver assistance system 1 of FIG. 1, the invention comprises the further aspect of boundary condition learning as relates to the driving style attributes. This learning process preferably occurs during a training phase during which the driver manually controls at least the longitudinal and lateral control of the vehicle 2. Further preferably, this learning process is in particular a continuous training: The driver assistance system 1 always switches into learning mode when the driver is guiding the vehicle 2 himself. Alternatively or additionally, a continuous learning mode can also occur during the automated guiding of the vehicle, as will be shown in the following.

In the training phase of the driver assistance system 1, values of at least one adjustment parameter for guiding the vehicle are recorded 101 and stored in the second data storage 15, in particular simultaneously with values of the at least one input parameter. Correlations ensue from respective value parameters at the same time or in a same time period which reflect driver reactions in different driving scenarios and thus contain information about the driver's driving style. Boundary conditions are determined 103 based on this information. The driver assistance system 1 accesses these predefined boundary conditions during highly automated or fully automated guiding of the vehicle 2 to achieve the most agreeable possible perception of the vehicle's guidance for the driver.

Additionally or alternatively to the adjustment parameter values, values of at least one body parameter which reflect the body function of an occupant, in particular the driver, can also be recorded 101. This can be performed by a smart device, particularly a smart watch. The objective values of the body parameter are thereby selected such that they can characterize a subjective perception of the driving style of a driver assistance system 1. Particularly feasible for this purpose are an occupant's heart rate, blood pressure, adrenaline level and/or respiratory pattern. The body parameter values are also correlated with the input parameter values; i.e. the different driving scenarios, and boundary conditions derived therefrom which serve as a rule for the vehicle guidance. The recording 101 of body parameters preferably continues during the highly automated or fully automated driving mode so that further data particularly for evaluating past driving scenarios and/or trajectories travelled can be obtained.

The correlation or respectively updated correlation is incorporated into the selection 107a/calculation 107b of the ideal trajectory.

The invention enables comprehensive optimization of vehicle operation by a driver assistance system 1. Not only are legal stipulations and safety-related requirements thereby incorporated into the vehicle guidance but also the driving styles preferred by a specific driver or specific group of drivers as defined by the driving style attributes. The driver assistance system 1 is thereby capable of independently adapting to the respective driver and vehicle or vehicle modifications respectively. This thereby ensures that the driver assistance system 1 offers an optimal driving style for the respective vehicle 2 or its vehicle configurations respectively and/or for the respective driver. Depending on the requirements of the current or future driving scenarios and the occupants of the vehicle 2, the energy consumption of the vehicle 2 can thereby be optimized. For example, all the driving scenario and boundary condition stipulations can thus be incorporated into an energy cost function. Based on the energy requirements of the different power units of the vehicle 2 for current and future driving scenarios, an energy cost can thereby be determined. By allocating value contingents to the different power units of the vehicle 2, each unit can conclude whether it decreases or feeds the available energy in the vehicle 2.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

### LIST OF REFERENCE NUMERALS

1 driver assistance system
2 vehicle
3a, 3b, 3d sensor
4 first data interface
5 second data interface
6 prediction module
7 optimization module
8 control module
9a, 9b road section
10, 10a, 10b, 10c trajectory
11 first data storage
12 central server
13a, 13b, 13c, 13d, 13e, 13f, 13g road user
14 driving style selector module
15 second data storage

What is claimed is:

1. A method for producing control data for rule-based driver assistance for guiding a vehicle by a driver assistance system, which comprises:
detecting values of at least one adjustment parameter for guiding at least one of the vehicle and a body parameter which at least partially characterizes body functions of a vehicle occupant;
detecting values of at least one input parameter which at least partially characterizes a driving scenario;
determining at least one boundary condition for adjusting the at least one adjustment parameter according to the at least one input parameter based on the detected values; and
emitting control data for guiding the vehicle which takes into account the at least one boundary condition as a rule.

2-15. (canceled)

16. The method according to claim 1, further comprising:
guiding the vehicle at least intermittently based on the control data.

17. The method according to claim 1, wherein the at least one boundary condition emulates a driver or driver group driving style.

18. The method according to claim 1, wherein the at least one boundary condition emulates an adapted driver or driver group driving style which reflects different perceptions of the driver or driver group between automatic guidance and manual guidance of the vehicle.

19. The method according to claim 1, wherein at least some values are recorded during automatic guidance of the vehicle by the driver assistance system.

20. The method according to claim 1, wherein the at least one adjustment parameter indicates whether the driver will stop automatic guiding of the vehicle by the driver assistance system, upon a constellation of the at least one adjustment parameter with the at least one input parameter.

21. The method according to claim 16, further comprising:
simulating, concurrent with the guiding of the vehicle, at least one future driving scenario based on values of the at least one input parameter and simulating at least one trajectory of the vehicle based on the at least one future driving scenario, wherein the control data is based on the at least one simulated trajectory.

22. The method according to claim 21, wherein the simulating step occurs in real time based on real-time data of a present driving scenario.

23. The method according to claim 21, wherein a plurality of possible prospective trajectories is simulated, and the method further comprises:
evaluating the plurality of possible prospective trajectories based on at least one boundary condition, wherein the control data reflects a best-rated prospective trajectory.

24. The method according to claim 1, wherein the at least one boundary condition characterizes a driving style attribute selected from the following group: driving time, emission, energy consumption, safety, driving dynamics, drivability, perceived efficiency, perceived safety.

25. The method according to claim 24, wherein a plurality of boundary conditions is considered, and corresponding driving style attributes are weighted differently.

26. The method according to claim 1, wherein the determining of the at least one boundary condition provides for the at least one body parameter to not exceed at least a predefined limit value.

27. A computer program containing instructions which, when run on one computer or several computers, prompt the computer or several computers to execute the steps of the method of claim 1.

28. A computer-readable medium stored on the computer program of claim 27.

29. A driver assistance system for assisting a driver in the guiding of a vehicle, comprising:
at least one sensor configured to at least partially detect driving situation data related to at least one of the vehicle and body parameter data of the driver,
a driving style selector module, wherein the driving style selector module comprises a data storage and is configured to access the driving situation data of the at least one sensor and data from at least one adjustment parameter for guiding the vehicle, wherein the driving style selector module is configured to store values of the at least one adjustment parameter and sensor data in the data storage and determine at least one boundary condition in relation to the at least one adjustment parameter as a function of stored data, and
an interface for emitting control data for guidance of the vehicle which takes into account the at least one boundary condition as a rule.
